(19) United States
(12) Patent Application Publication
(10) Pub. No.: US 2007/0131499 A1
(43) Pub. Date: Jun. 14, 2007

(54) Integrated brake, suspension and wheel system

(76) Inventor: Dinesh C. Seksaria, Novi, MI (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 11/300,241

(22) Filed: Dec. 14, 2005

(51) Int. Cl. F16D 65/10

(52) U.S. Cl. 188/218 R; 188/73.1

(57) ABSTRACT

A braking system comprising a friction surface disposed along an inner surface of a wheel; and a suspension component housing at least one extendable brake pad, wherein said brake pad engages said friction surface when in an extended position.

### FIELD OF THE INVENTION

The present invention relates to brake systems for use in vehicles.

### BACKGROUND OF THE INVENTION

Many different types of vehicle brake systems have evolved over the last 100 years ranging from pure mechanical devices to more sophisticated systems incorporating hydraulic and/or electromagnetic principals to brake or assist in braking the vehicle.

In all cases the kinetic energy of the moving vehicle must be absorbed by the braking system, wherein the kinetic energy is typically absorbed by being converted into heat. Modern vehicles are of significant mass and travel at significant speeds, hence producing a large amount of kinetic energy that must be dissipated quickly by conversion to heat in the brake system with minimal effort by the driver. Typically, this is accomplished in todays cars by hydraulically assisted brake pads (pucks) frictionally contacting brake disks (rotors) or drums.

Additionally, braking may be assisted by multi-brake pad (puck) independently controlled antilock braking. Although, these systems increase the safety and handling quality of the vehicle, the systems also increase the vehicle's weight, complexity and cost. By increasing the mass of the brake system the vehicles kinetic energy is increased at speed, wherein the increased mass also disadvantageously decreases the vehicles handling abilities and fuel efficiency.

One disadvantage of conventional brake systems is that heat generation, the mechanism by which the kinetic energy of the moving car is dissipated, has an adverse effect on the braking system's effectiveness and reliability. Generally, as the brake system continues to generate heat through multiple applications, the ability of the brake system to stop the car is decreased. The increase in stopping distance with multiple braking applications is commonly referred to as “brake fade”. Managing heat generation of the brake system, the brake systems mass, and the brake systems durability are significant challenges to car designers.

In light of the above, what is needed is a brake system that is lighter in weight, reliable, cost efficient, and provides improved safety, performance, and fuel efficiency in today's cars.

### SUMMARY OF THE INVENTION

The present invention provides an inventive brake system, in which the braking surfaces are positioned along an interior surface of the rim portion of at least one wheel. The inventive brake system integrates the functions of the wheel, brake and the suspension taking advantage of aluminum's low weight, high thermal capacity, and high conductivity in dissipating heat while stopping the vehicle quickly, safely, and reliably. Broadly, the inventive braking system comprises:

a friction surface disposed along at least a portion of an inner surface of a wheel; and

a suspension component housing at least one extendable brake pad, wherein said brake pad frictionally engages said friction surface when in an extended position.

In one embodiment the friction surface may be disposed on at least a portion of the inner surface of the rim portion of the wheel. The friction surface may comprise a hard wear resistant material, such as a ceramic or carbide or organic metallic composites.

In one embodiment, the friction surface may be in the form of a friction ring disposed along an inner surface of the rim portion of the wheel. The friction ring may be mechanically or adhesively attached to the wheel's rim portion.

In another aspect of the present invention, a method is provided for braking a vehicle. Broadly, the inventive method of braking a vehicle comprises the steps of:

providing a wheel comprising a frictional surface disposed along at least a portion of an inner surface of said wheel;

providing at least one brake pad extendably mounted to a suspension component of a vehicle; and

contacting said at least one brake pad to said frictional surface.

### BRIEF DESCRIPTION OF THE DRAWINGS

FIGS. 1a and 1b (prospective view) depict a brake and suspension system in which the inner surface of the wheel functions as a brake surface.

FIG. 2 (side view) depicts a wheel having a brake surface on the inner surface of the wheel's rim portion.

FIG. 3 (side view) depicts a wheel having a brake surface ring disposed along the inner surface of the wheel's rim portion.

### DETAILED DESCRIPTION OF PREFERRED EMBODIMENTS

The present invention provides an inventive brake system, in which a braking surface is positioned along an interior surface of the wheels. The present invention is now discussed in more detail referring to the drawings that accompany the present application. In the accompanying drawings, like and/or corresponding elements are referred to by like reference numbers.

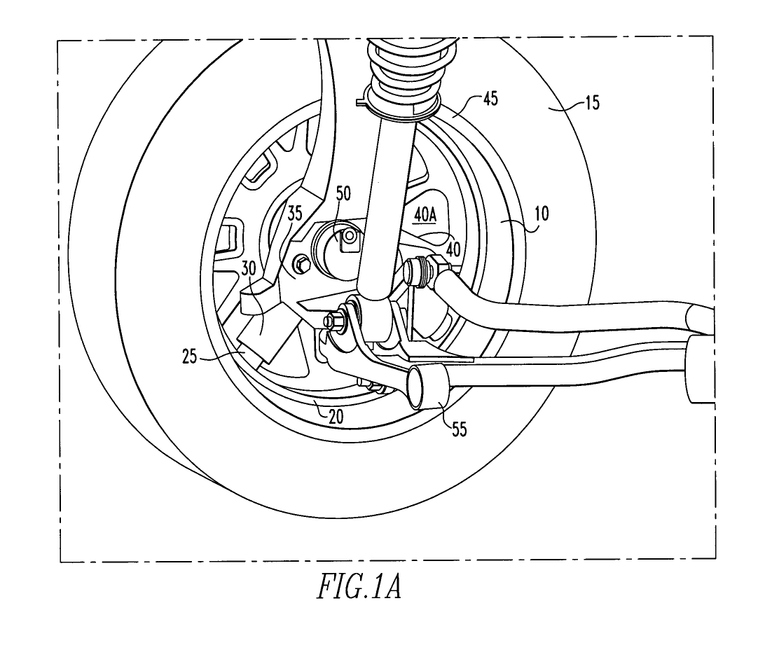

Referring to FIGS. 1a and 1b, a brake and suspension system is provided comprising a wheel 10 with an outer surface having provisions for mounting a tire 15 and an inner surface 20 (also referred to as a braking surface) having provisions for a braking surface. At least one brake pad 25 and actuating means 30 is positioned mounted to at least a portion of the vehicle's suspension system 35, wherein the brake pad 25 may be positioned to extendably engage and/or disengage in frictional contact to the braking surface 20 disposed along the wheel's inner surface. The wheel includes a center portion 40 and a rim portion 45, wherein the frictional surface may be formed along the inside of the rim 45. In a preferred embodiment, the wheel 10 comprises aluminum or a like material capable of dissipating heat at a high rate. The center portion 40 of the wheel 10 may include as least one cooling means, such as a cooling vent 40a, wherein the cooling means may be integrated into a stylized design. The aluminum wheel structure and cooling means work to dissipate heat generated during braking to reduce brake fade. More specifically, the aluminum wheel 10 absorbs thermal transients produced by engagement of the brake pad 25 and the friction surface 20, and the cooling means is configured to direct air flow across the friction surface 20 and brake pads 25.

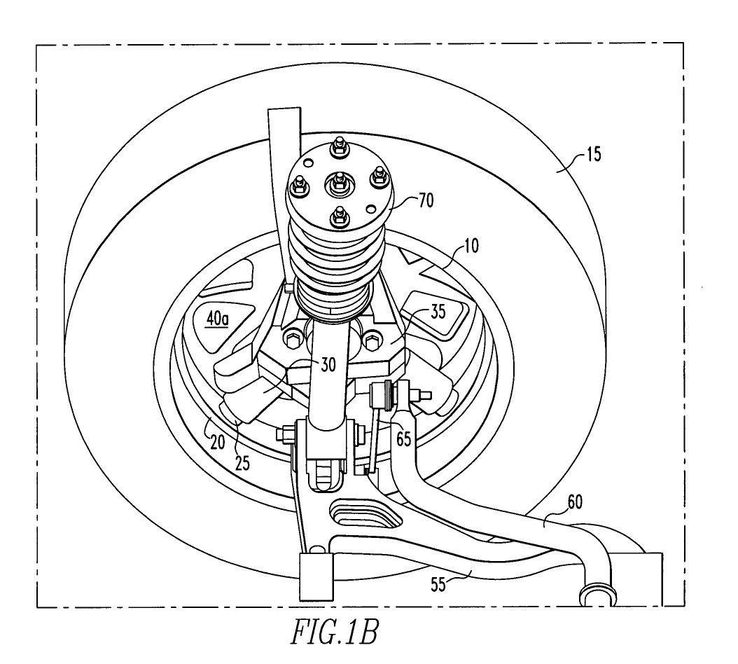

Referring to FIG. 2, in one embodiment, the frictional surface 20 may be disposed at least a portion of the inner surface of the rim portion 45 of the wheel 10. The friction surface 20 may comprises any hard wear resistant material, such as a ceramic, carbide or organic metallic composite. The frictional surface 20 may be applied to the inner surface of the rim 45 using deposition techniques including, but not limited too: plasma spray, flame spray, electroplating or like deposition processes and combinations thereof. In some embodiments, the frictional surface 20 may be formed or embedded into the wheel's 10 rim portion 45. Regardless of the forming or embedding technique, the wheel 10 in its final form, including the frictional surface 20, must be balanced. In order to achieve a rotational balance, the frictional surface 20 may be trued by machining, grinding or polishing.

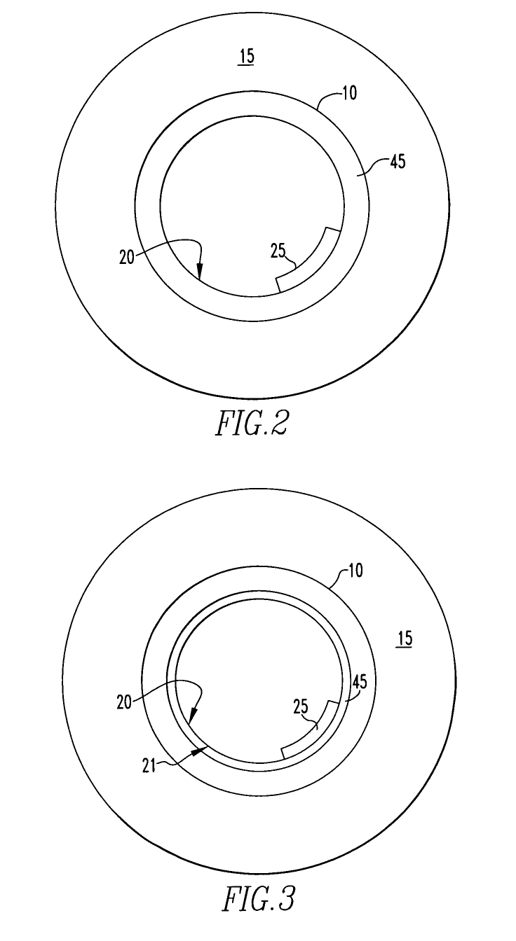

Referring to FIG. 3, in another embodiment, the friction surface 20 may be in the form of a friction ring 21 disposed along an inner surface of the rim portion 45 of the wheel 10. The friction ring 21 may comprise any hard wear resistant frictional material, such as a ceramic, carbide or organic metallic composites. The friction ring 21 may be welded, mechanically attached or adhesively attached to the wheel's rim portion 45. In one example, the frictional ring 21 may mechanically attached by fasteners that may be disengaged for replacement of the friction ring 21. It is noted that any attachment means, may be utilized to connect the friction ring 21 to the wheel structure 10, so long as the wheel 10 may be rotationally balanced.

The brake system further comprises at least one brake pad 25 and actuation means 30 positioned to provide that the brake pad 25 may be extended into frictional contact with the frictional surface 20, as depicted in FIG. 2, or engaged to the frictional ring 21, as depicted in FIG. 3. The brake pads 25 may comprise any braking material used in transport applications, including but not limited to: semi-metallic brake materials, ceramic brake materials, or organic brake material. The actuation means 30 may include pneumatic, electro-servo, electromagnetic or hydraulically extendable cylinders, preferably being hydraulically extendable cylinders.

Referring to FIGS. 1a and 1b, in one embodiment, the suspension component 35 that the brake pads and actuating means are integrated with a knuckle. In addition to providing the integration point for the brake pads 25 and actuating means 30, the knuckle further comprises a means to provide rotational engagement with the wheel 10. In one embodiment, the actuating means may be in the form of a subassembly that is attached to the knuckle, wherein attachment may be achieved by mechanical means. In a preferred embodiment, the knuckle comprises aluminum and may further comprise hydraulic and/or electrical pathways in communication to the actuation means of at least one brake pad. In one alternative embodiment the knuckle may be cast ferrous metal.

In one embodiment, the knuckle may include a sensor 50 housed within said knuckle, wherein the sensor 50 is configured to determine the rotation speed of the wheel 10. Preferably, the sensor is a component of an anti-lock brake system, wherein the anti-lock system further comprises at least one valve positioned along the hydraulic pathways of the knuckle.

The knuckle may further comprises attachment points for further suspension means, including but not limited to: control arms, sway bars, sway bar end links, coil springs, transverse springs, shocks, struts, coil-over shocks, wheel bearings, camber rods, trailing arms, ball joints, toe rods, and tie-rods.

Having described the presently preferred embodiments, it is to be understood that the invention may be otherwise embodied within the scope of the appended claims.

What is claimed is:

1. A braking system comprising:
a friction surface disposed along an inner surface of a wheel; and a suspension component housing at least one extendable brake pad, wherein said brake pad engages said friction surface when in an extended position.

2. The brake system of claim 1 wherein said inner surface of said wheel is a rim portion.

3. The brake system of claim 2 wherein said friction surface disposed along said inner surface inner surface of said rim portion of said wheel comprises a ceramic, carbide or organic metallic composite.

4. The brake system of claim 2 wherein said friction surface disposed along said inner surface said inner surface of said rim portion of said wheel comprises a friction ring.

5. The brake system of claim 4 wherein said friction ring comprises a semi-ceramic, carbide or organic metallic composite.

6. The brake system of claim 4 wherein said friction ring is mechanically or adhesively attached to said wheel.

7. The brake system of claim 6 wherein mechanically attached comprises fasteners that may be disengaged for replacement of said friction ring.

8. The brake system of claim 1 wherein said wheel absorbs thermal transients produced by engagement of said at least one brake pad and said friction surface.

9. The brake system of claim 1 wherein said wheel is configured to direct air flow across said friction surface and said at least one brake pad.

10. The brake system of claim 1 wherein said wheel comprises aluminum.

11. The brake system of claim 1 wherein said at least one brake pad comprises a semi-metallic, ceramic, or organic brake material.

12. The brake system of claim 1 wherein said at least one brake pad is extended hydraulically, electrically or electro-magnetically.

13. The brake system of claim 11 wherein said suspension component comprises aluminum.

14. The brake system of claim 13 wherein said suspension component comprises a knuckle in rotational engagement with said wheel, said knuckle comprising cylinders for containing said at least one brake pad.

15. The brake system of claim 14 said knuckle further comprising hydraulic pathways in communication with said at least one brake pad.

16. The brake system of claim 15, wherein said knuckle further comprises attachment points for further suspension means.

17. The brake system of claim 16 wherein said further suspension means are selected from the group consisting of control arms, sway bars, sway bar end links, coil springs, transverse springs, shocks, struts, coil-over shocks, wheel bearings, camber rods, trailing arms, ball joints, toe rods, and tie-rods.

18. The brake system of claim 17 wherein said knuckle further comprises a sensor housed within said knuckle.

19 The brake system of claim 18 wherein said knuckle further comprises a sensor determining the rotation speed of the wheel.

20. The brake system of claim 19 wherein said sensor is a component of an anti-lock brake system, wherein said anti-lock system further comprises at least one valve positioned along said hydraulic pathways of said knuckle.

21. A method of stopping a vehicle comprising:
providing a wheel comprising a frictional surface disposed along at least a portion of an inner surface of said wheel;
providing at least one brake pad extendably mounted to a suspension component of a vehicle; and
contacting said at least one brake pad to said frictional surface.

22. The method of claim 21 wherein said wheel comprises aluminum.
